(19) United States
(12) Patent Application Publication
(10) Pub. No.: US 2002/0161697 A1
(43) Pub. Date: Oct. 31, 2002

(54) On-line procurement or RFP auction system

(76) Inventors: Charles M. Stephens, Dania, FL (US); Roger C. Kostman, Fort Lauderdale, FL (US); Ashley Brizendine, Fort Lauderdale, FL (US)

Correspondence Address: Melvin K. Silverman, MELVIN K. SILVERMAN & ASSOC, P.C., 4901 NORTH FEDERAL HIGHWAY, SUITE 440, FORT LAUDERDALE, FL, 33308, US

(21) Appl. No.: 10/126,515

(22) Filed: Apr. 22, 2002

Related U.S. Application Data
(60) Provisional application No. 60/287,008, filed on Apr. 30, 2001.

(51) Int. Cl. G06F 17/60

(52) U.S. Cl. 705/37

(57) ABSTRACT

An on-line RFP procurement auction system with bidder sub-auctions, using an Internet based communications network of network members inclusive of network buyers/requesters and network sellers/bidders, for processing an RFP for goods and services through at least one server and operating software. The system including a database for each category of goods and services offered or desired by network members of the system; photo upload capability for remote use by network buyers to particularly illustrate and explain the desired RFP service; capacity for network buyers to generate RFPs for goods or services displayed by jpegs and the like of photo uploads together with alpha-numeric RFP data; capacity for transmitting the RFPs inclusive of jpegs to the server; capacity for e-mail and wireless distribution of RFP notices to those network sellers/bidders; that have asked for notices within selectable categories of RFP's; capacity to enable a network seller/bidder to submit an encrypted bid to the server; and capacity within the server for generating a list of all responsive bids and e-mailing the same to the buyer/requester generator after conclusion of an auction.

### REFERENCE TO RELATED APPLICATION

This case claims the benefit under 35 U.S.C. 119(e) of Provisional Application Serial No. 60/287,008, filed Apr. 30, 2001, and the same is incorporated in full by reference herein.

### N/A

### BACKGROUND OF THE INVENTION

1. Field of Invention

This invention relates to the area of electronic commerce on the Internet and, more particularly, to an on-line procurement system in which responses to requests for proposals (RFPs) are solicited over the Internet.

2. Description of Related Art

On-line or Internet based auctions have become popular in recent years and, as such, have become an integral aspect of electronic or e-commerce as it is known today. Such auctions are technically known as forward auctions or highest bid wins auctions. Examples of such on-line systems are reflected in U.S. Pat. No. 5,895,454 (1999) to Harrington; U.S. Pat. No. 5,890,138 (1999) to Godin, entitled Computer Auction System; U.S. Pat. No. 6,021,398 (2000) to Ausubel; and U.S. Pat. No. 6,101,485 (2000) to Fortenberry et al, entitled Electronic Solicitations for Internet Commerce. Although the various hardware, software, and Internet means for effecting such forward or high-bid auctions may differ, the objective is always the same, that is, to solicit the highest possible offer for the particular goods or product that is the subject of the auction.

Less common are auctions of services, in that services do not as readily lend themselves to e-commerce, this for a number of reasons, including the personalized nature of most services, even where the object of the service is an inanimate object, e.g., as in the repair of an automobile. Accordingly, the development of e-commerce relative to services has been largely informational in character, with actual transactions rarely occurring. Yet less common in contemporary e-commerce is the so-called RFP, quotation, or procurement auction in which it is the buyer, not the seller, that initiates the auction process and in which the sellers that compete with each other. This is also known as a low-bid wins auction. Clearly, the development of low bid auctions is in the interest of the public. The instant invention, while capable of forward auction functions, as is described herein, is primarily directed to RFP auctions for services in which RFPs are solicited for the rendering of particular services within a given industry.

Although the present system, as described herein, is the result of needs of the marine industry and cargo transportation industry, and more specifically marine insurance companies soliciting competitive bids for vessel and cargo repair in what heretofore has been essentially a closed noncompetitive procurement process. The principles of the invention are applicable to substantially any business having recurrent needs for particular types of goods and services as a part of a procurement process. That is, buyers in need of goods or services often spend considerable time in the location of an appropriate vendor. Buyers, known as purchasing agents in larger companies, may employ trade publications, directories, recommendations and other means to locate prospective vendors. Conversely, vendors may advertise through various media and, in the case of goods, by direct sales methods to make known to potential buyers the existence of their goods and services, and how to contact them.

When a prospective buyer identifies a group of qualified vendors, each must be contacted to obtain a product or service price, as well product as availability, delivery time and other information. This is of course a time consuming process in which companies will, where necessary, rely on experienced purchasing agents to accomplish the same. However, in certain situations, as are commonplace in the marine cargo and other businesses, the need for a given product or service may be particularly time sensitive, this because of geographical factors, limited number of qualified vendors and, in the case of a damaged vessel, the impracticality of moving the vessel out of the boatyard or dockage at which it is located. Likewise, perishable cargo has a short shelf life and therefore requires timely bids for purchase or repair. Accordingly, persons and companies requiring services in connection with damaged vessel and cargo and insurers thereof often find themselves with few options with respect to marine surveyors and adjusters, on the one hand, and boatyards, shipyards, cargo salvors, and their subcontractors on the other hand.

While the primary need for such procurement of services arises in the area of marine insurance and warranty work for boat and marine engine manufacturers (the so-called B2B e-commerce) there, as well, exist significant needs on the part of private boat owners having uninsured needs, such as repair, re-fits, re-painting, re-powering. These needs more than justify an on-line bid, quote, or RFP system of the present type.

On-line systems which generate RFPs for services are rare and, with respect to issued patents, appear only in U.S. Pat. No. 5,758,328 (1998) to Giovannoli, entitled Computerized Quotation System and Method. The point of novelty of Giovannoli is however the filtering of RFQs such that sets of a priori conditions must be met by a prospective bidder before the bid process can commence. In distinction, the present system, known as the MBx system, relies upon a combination of network membership and information secured through membership registration in order to determine subsets of prospective bidders meeting one or more of particular requirements or parameters of a particular RFP network buyer/requester, or the network itself, this including, for example, such factors as geography, capability, experience, peril classification, language spoken and conditions of sale or offer. RFP Bidder evaluation of this level of sophistication cannot be obtained through the system of Giovannoli or any other art known to the within inventors. Further, the system of Giovannoli is essentially that of a buyer/vendor network lacking a rigid structure or operating through a central network-processing unit (“CNPU”). The present system, in distinction, is wholly reliant upon an administrative server or CNPU for the many benefits of the invention as are more fully set forth below.

### SUMMARY OF THE INVENTION

Set forth herein is an on-line procurement RFP (low-bid) auction system, inclusive of bidder sub-auctions, using an Internet based communications network of network members inclusive of network buyers/requesters and network sellers/bidders, for processing RFPs for goods and services through at least one server and operating software therefore. The system more particularly includes a database for each category of goods and services offered or desired by network members of the system; a photo-upload utility for remote use by network buyers to particularly illustrate and explain the desired service; means for network buyers to generate RFPs for goods or services as is specified by jpegs and alpha-numeric RFP data; means for transmitting said RFPs to said server; database search means of determining the best candidate network member bidders for each particular RFP; means for e-mail and wireless distribution of notices of said RFPs to suitable network sellers/bidders; means for enabling network sellers/bidders to submit an encrypted bid to said server; and means within said server for generating a list of all responsive bids, and e-mailing a notice to the network buyer/requester generator thereof after conclusion of an auction period. The system is facilitated through a database having partitions inclusive of registration form data, a service provider data, categories of goods and services data for high bid auctions, bidding sub-contactors data and links to seller/bidder profile mini-web pages including jpegs and profiles thereof. The system further includes many elective pop-up tutorials to assist new users throughout the different phases as well as an automated e-mail invoicing system for charging of commissions to network buyers/requesters of RFP auctions predicated upon the lowest received bid, even if such bid is not the bid selected by the ultimate network buyer/requester. The system also provides automated e-mail start and finish notifications to the buyer/requester standard or custom buyer/requester messages notifying the best candidate of its selection and the losing bidder notifications.

It is accordingly an object of the present invention to provide a method and system of electronic commerce particularly adapted to the solicitation of bids for the procurement of goods and services by a prospective buyer (RFP requester) from a subset of prospective network sellers/bidders.

It is another object to provide a system of the above type having particular application to companies or individuals, such as insurance companies, private boat owners, private and commercial waterfront owners, marinas, municipal beach and lake restoration, and vessel manufacturers having warranty service requirements relative to marine related products.

It is another object of the invention to provide a method and system of the above type to enable companies and individuals that sell marine related products or services, such as boatyards and shipyards, marine repair facilities, engine and equipment dealers, boat trailer manufacturers, boat towing companies, boat transporting companies, dredging companies, dock and sea wall companies, and beach restoration companies, to increase the size of their potential markets and to impart a higher degree of professionalism to their respective businesses.

The above and yet other objects and advantages of the present invention will become apparent from the hereinafter set forth Brief Description of the Drawings, Detailed Description of the Invention and claims appended herewith.

### BRIEF DESCRIPTION OF THE DRAWINGS

FIG. 1 is a conceptual illustration of the categories of network members of the present system.

FIG. 2 is a conceptual block diagram showing the ultimate inputs and outputs of the inventive system when employed as a RFP (low bid) auction.

FIGS. 3 and 4 are a respective chart and web page that elaborate the information of FIG. 2.

FIG. 5 is a state block diagram showing the constituent functions of the system server (CNPU) and its relationship to the database of registration forms, categories of goods, service providers, and elective tutorials for explanation of registration forms, bid forms, RFPs, and other forms.

FIG. 6 is a system flow diagram showing the relationship of the various functions of the system of FIG. 5, databases thereof, and relationships therebetween.

FIGS. 7 to 12 are bidder response webpages for a single RFP.

FIG. 13 is a web page of the system used to generate and post an RFP.

FIG. 14 is a web page used to view an RFP.

FIG. 15 is a web page used by a seller/bidder to limit categories of RFP to be received, to establish a personal e-mail notification of auctions in categories of seller/bidder interest.

FIG. 16 is a page for RFP management.

FIG. 17 is a conceptual flow diagram of the ultimate inputs and outputs of the present system when used as a forward (high bid) auction.

FIG. 18 is a group of forward auction thumbnail photos that may be clickably zoomed.

FIG. 19 is a flow diagram of registration and navigation routines applicable to network bidders and insurance company requester.

FIG. 20 is a flow diagram of registration and navigation routines of the program applicable to network members desirous of availing themselves of all capabilities of the instant system.

FIG. 21 is a site map of the system.

FIG. 22 is a FAQ page.

FIG. 23 is a block diagram, with annotations, providing a summary of system capability for B2B and C2B purposes.

FIGS. 24 to 26 shows search options of the system.

### DETAILED DESCRIPTION OF THE INVENTION

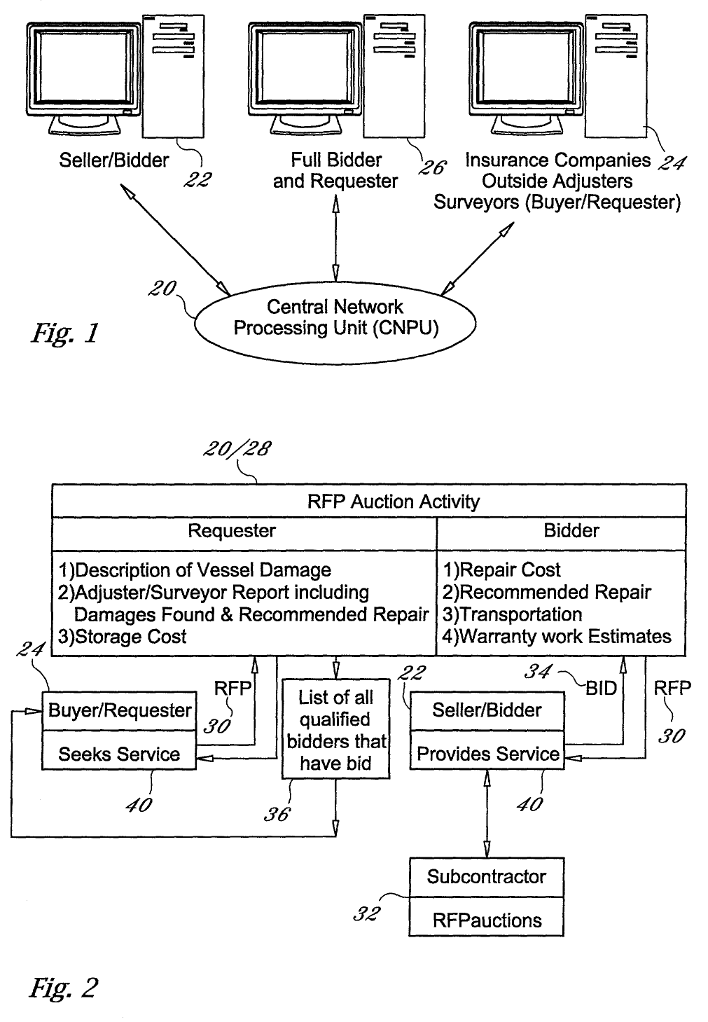

In FIG. 1 is shown the conceptual relationship between a central network processing unit (“CNPU”) or network server 20 of the present invention and the categories of users thereof, namely, a seller/bidders 22, also referred to herein as a network seller/bidder, and parties that generate procurement requests, that is, parties that generate RFPs, such parties herein referred to as a network buyer/requester 24. Between the network member seller/bidder 22 and network member buyer requester 24 are parties 26 who wish to participate in the bidding as well as the requesting side of the instant system. Such parties will typically also participate in conventional high bid auctions, as are more fully set forth below. Therefore, such prospective bidders are termed “full bidders” in the terminology of the instant system.

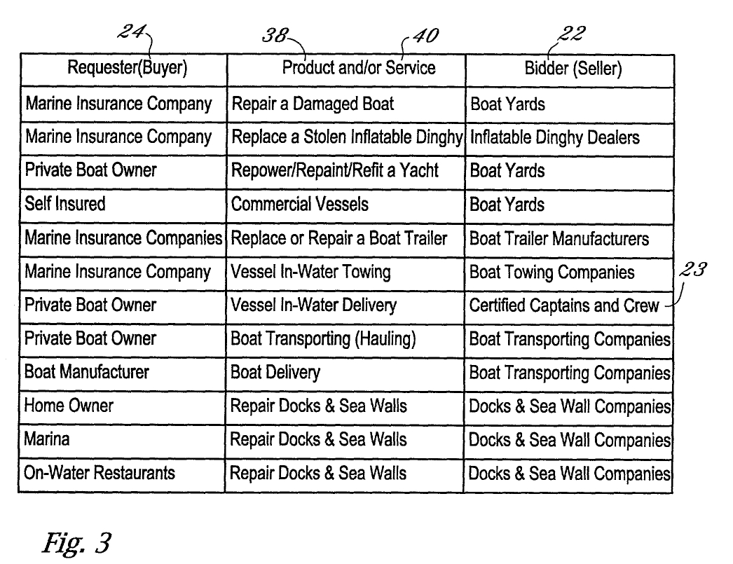

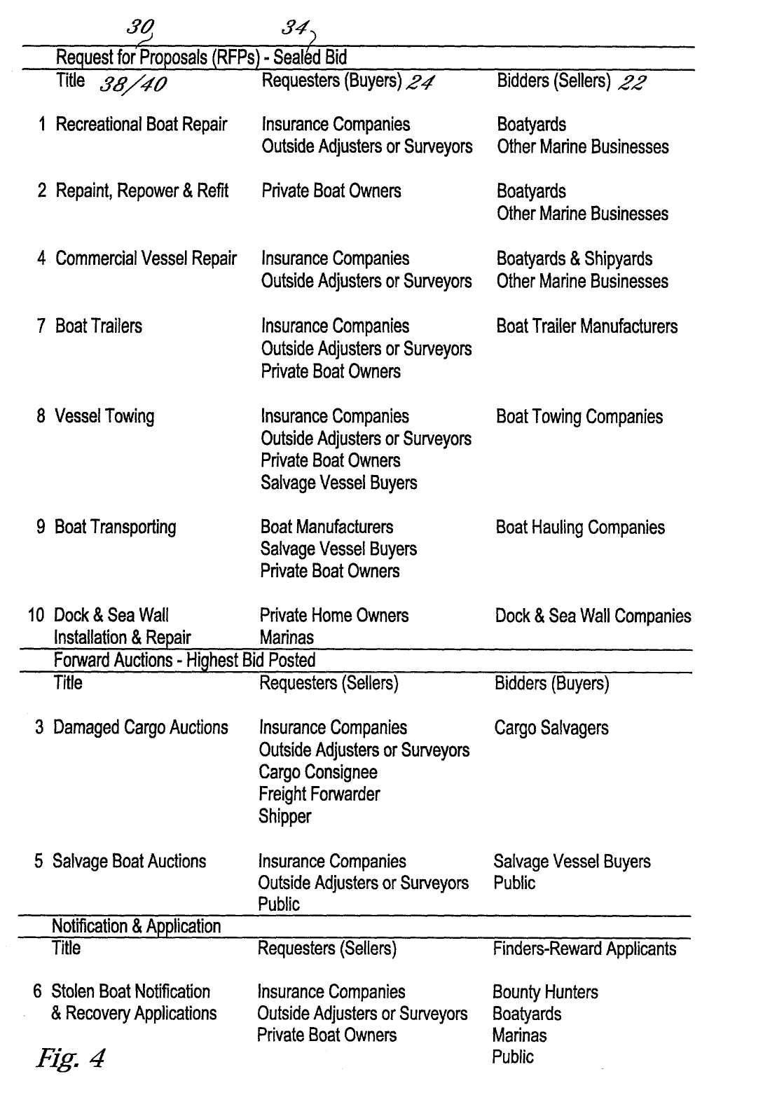

With reference to the flow diagram of FIG. 2, the basic inputs and outputs of the on-line procurement auction system are shown. More particularly, at the center thereof is RFP auction function 28 which, as is more fully set forth below, comprises a subset of the functions of server or CNPU 20 referenced above. A partial listing of the RFP functions include: description (both written and visual) of vessel or cargo damage, insurance assessment, surveyor report, storage costs, repair costs, SRILLI costs, time to complete the job, sales tax, percent of total repair for expected supplement, salvage value, vessel and cargo transportation cost, and warranty work estimates. To the left of RFP auction function 28 is buyer/requester 24, that is, the party seeking a bid for a particular service. The buyer requester 24 will generate an RFP 30 which is transmitted by the network server 20 to seller/bidder 22. Therein, the prospective bidder may avail himself of the RFP function for network members who are subcontractors 32 that might offer goods or services needed by the prospective bidder to formulate a responsive bid 34 to in response to RFP 30. This bid will be processed by network server 20 in accordance with the program below set forth, and as one of its outputs will furnish to the buyer/requester 24 a list 36 of all qualified bidders that have responded to a particular RFP 30 with bids. Examples thereof, namely RFPs and their participants are shown column format in FIG. 3 and web page format in FIG. 4. These, more particularly, indicate subject matter correlations between requesters 24 and bidders 22 with respect to particular goods/products 38 and/or services 40. Therein may be appreciated the range of parties that may comprise potential network buyer/requesters, on the one hand, and network sellers/bidders, on the other hand, as well as the range of goods and services to which the instant system, in its marine industry embodiment, is applicable.

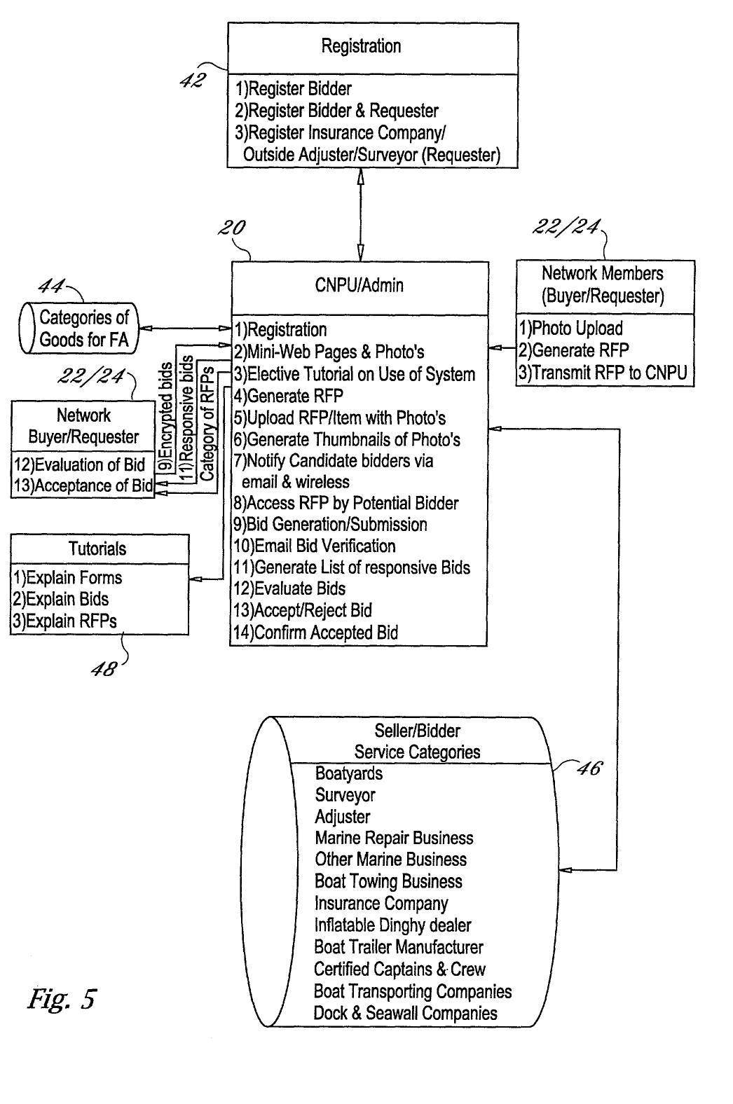

With reference to the state diagram of FIG. 5, there is shown, within network server/CNPU 20, a list of the network server functions in the sequence in which they would typically occur during system operation. More particularly, this sequence of functions is as follows:

1. Registration by category of network member.

2. Automatically generated registrant profile into a mini-web page with photos.

3. Elective pop-up tutorials for use on an as needed basis

4. Generation of RFPs 30 with unlimited items, each having up to four photos per item.

5. Upload of RFP items and all photos.

6. During photo upload process, CNPU 20 automatically generates thumbnail size photo on the display in the correct order for pop-up to larger photos.

7. E-mail and wireless distribution of RFP notices.

8. Bidder accesses RFP on-line.

9. Bid generation and submission.

10. E-mail bid verification back to the seller/bidder.

11. Generation of list of bids available to all participant bidders of an auction immediately after it has closed. The RFP buyer/requester is electronically notified of all itemized bids after payment of the service fees to MBx has been made.

12. Evaluation of list of bids by requester.

13. Acceptance or reject all bids of bid by requester.

14. Confirmation by server of acceptance of bid.

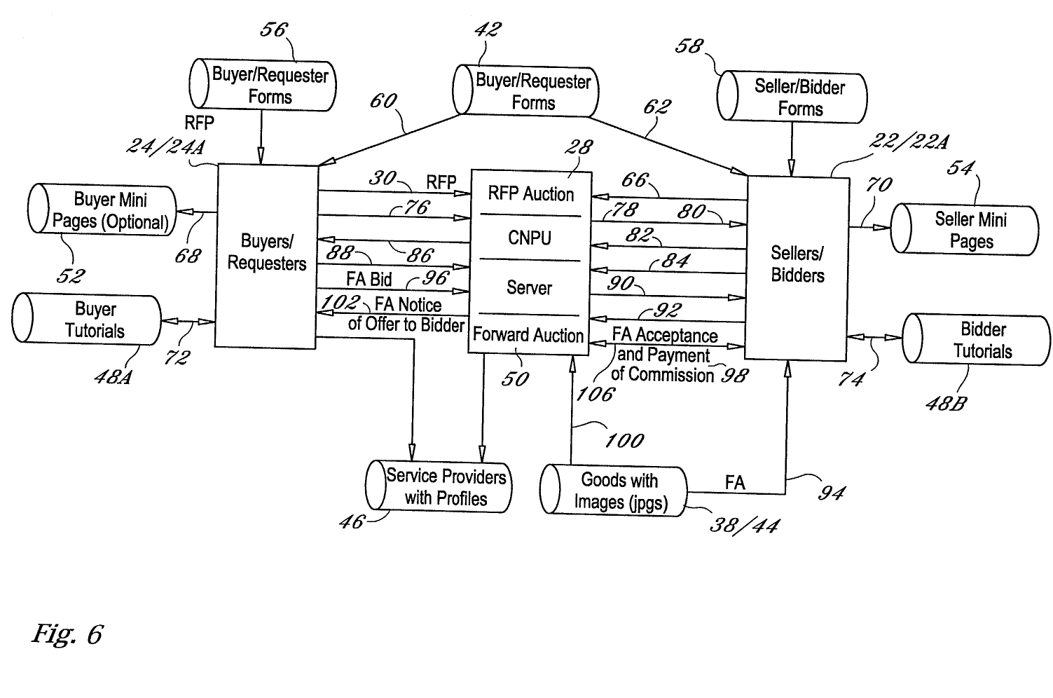

Some of the above functions are additionally shown within the network member blocks 22/24 shown to the left and right of CNPU network server 20 in FIG. 5. Block 42, which appears above server block 20, provides an indication of the range of different registration forms associated with the present system. This is more fully addressed with reference to FIGS. 6 and 19-20 below.

In FIG. 5, it noted that each functional database comprises a data partition of a single physical database. That is, database 44 contain categories of goods 38 such as boats or components thereof which are typically the subject of a forward auction, either generally as set forth below or, specifically, with reference to subcontractors 32 as above described with reference to FIGS. 2. Database 46 is a database of seller/bidder service providers and bidder profiled mini-webpages with photos, that are network members who, on a particular occasion, may function as either a network buyer 24 or network seller 22. Elective pop-up tutorials 48 assist any network member in the use of registration forms, bid forms, RFP forms, and other aspects of the system, as are set forth below. An applicable elective pop-up tutorial is linked from substantially any page of the present program (known commercially as MarineBidExchange.com.)

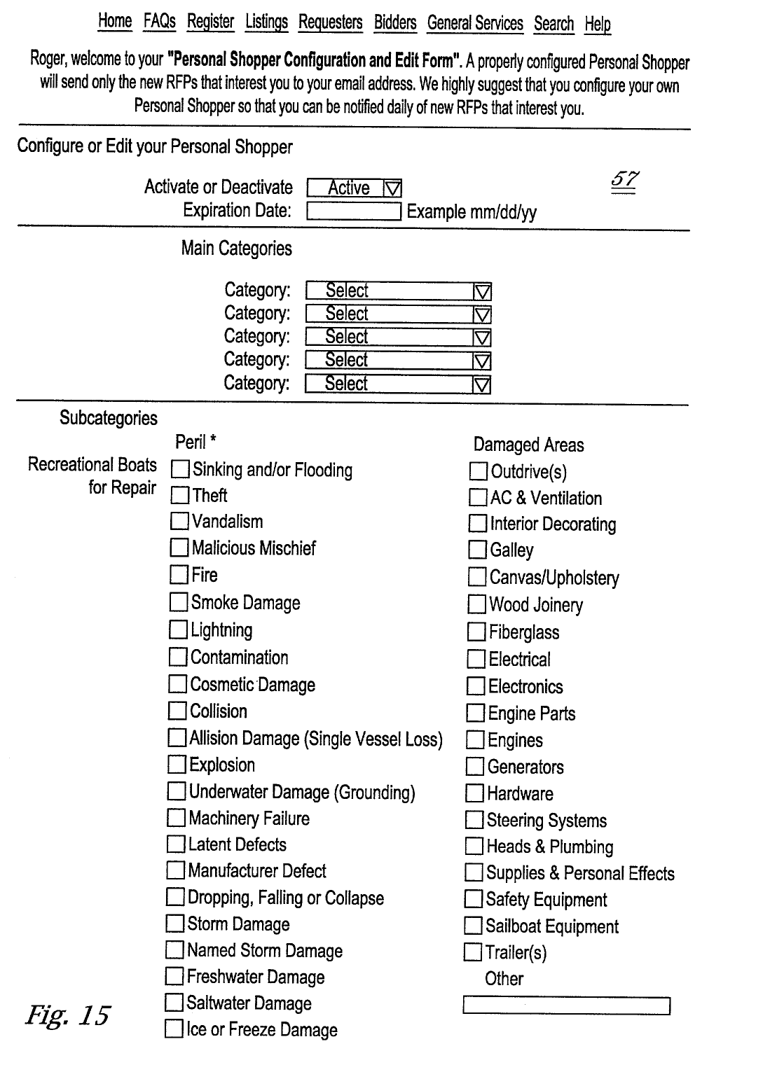

With reference to the network flow diagram of FIG. 6, there is shown the relationship between CNPU or server when employed both as a RFP auction 28 and a forward auction 50. Therein is included the buyer/requester 24, the seller/bidder 22, said database 44 of goods, said database 46 of service providers, optional buyer profile mini-pagers 52 inclusive of jpegs, seller profile mini-pages 54 inclusive of jpegs, said registration forms 42, database 56 of RFP forms for buyers/requesters, database 58 of forms for sellers/bidders, database 48A of buyer elective pop-up tutorials and database 48B of bidder elective pop-up tutorials. FIG. 6 however is particularly notable in its illustration of information flow which enables each of the above set forth server functions of FIG. 5. More particularly, registration of buyers/requesters is shown through Lines 60 and 62 which indicate provision of appropriate registration forms 56 and the submission of the completed forms to the server 20, while Line 66 illustrates the completion of an appropriate registration form by a seller/bidder and the submission thereof to server 20. Line 57 indicates that the network buyer 24 may customize his form, as is more fully set forth in FIG. 15.

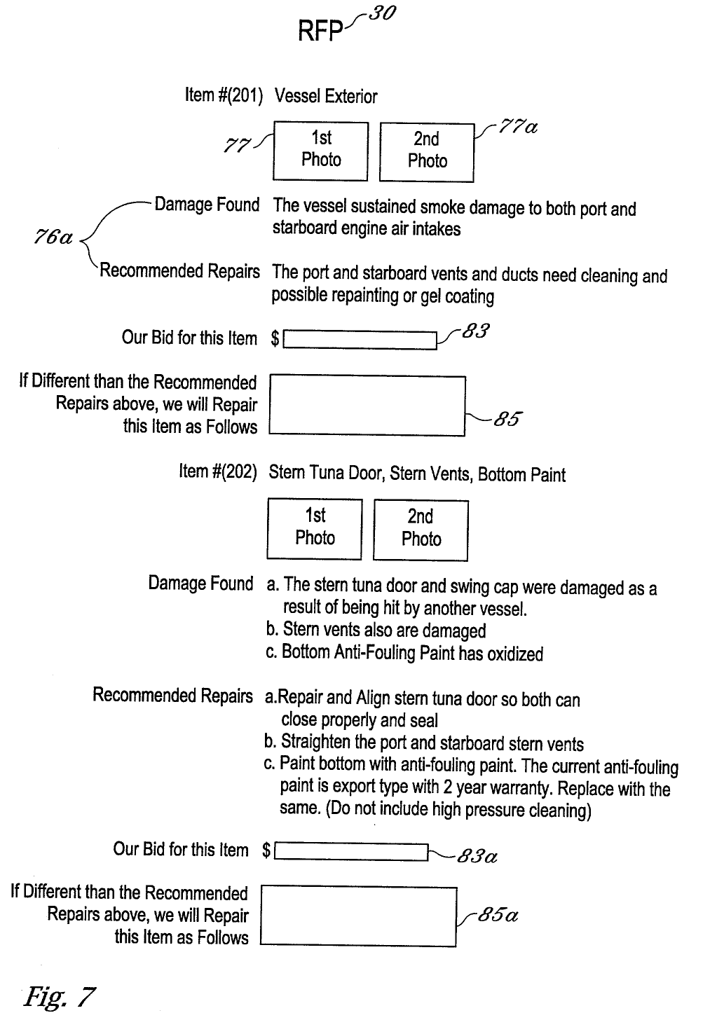

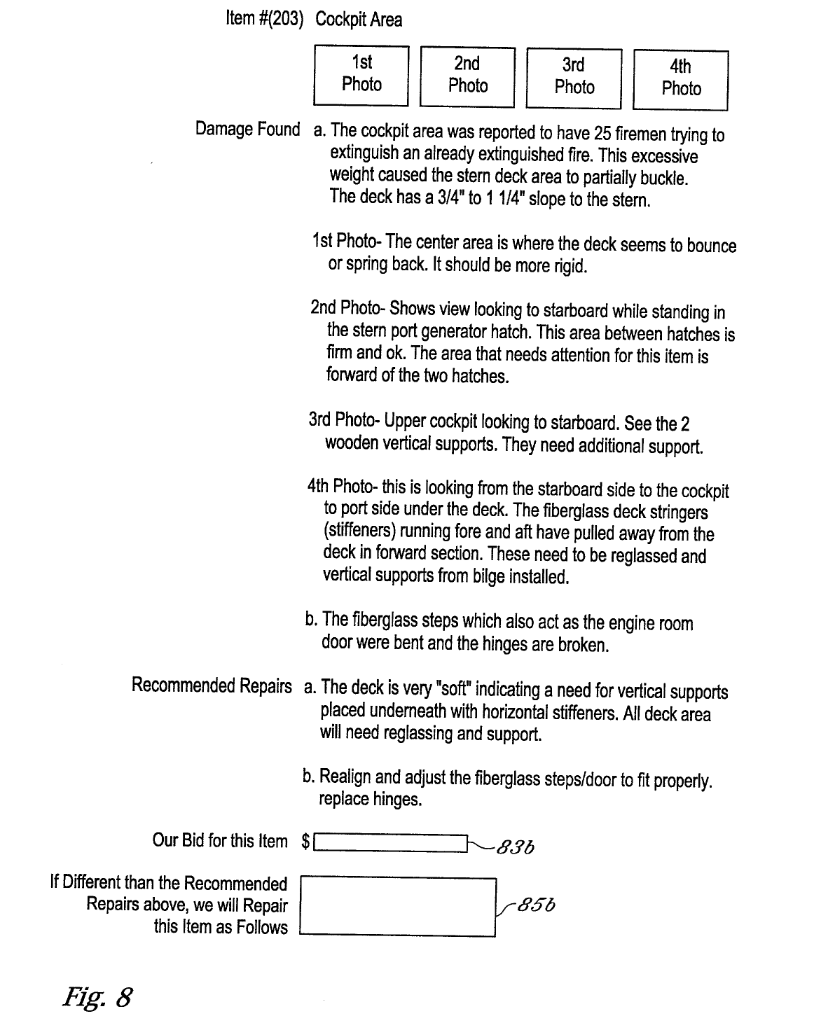

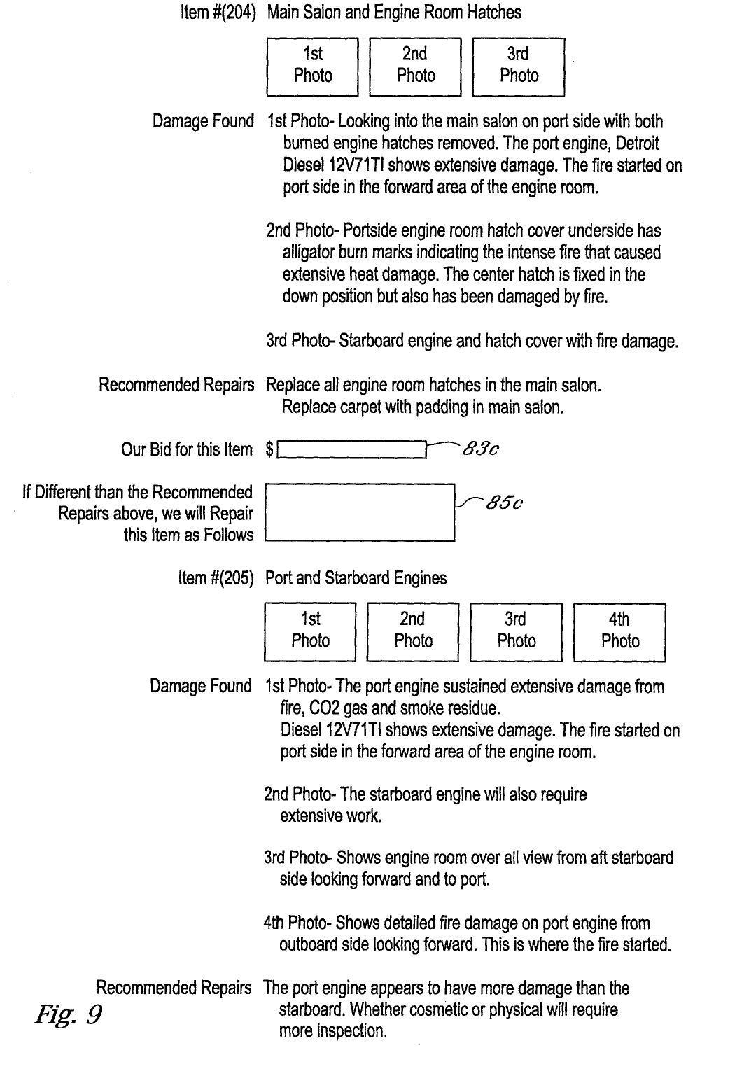

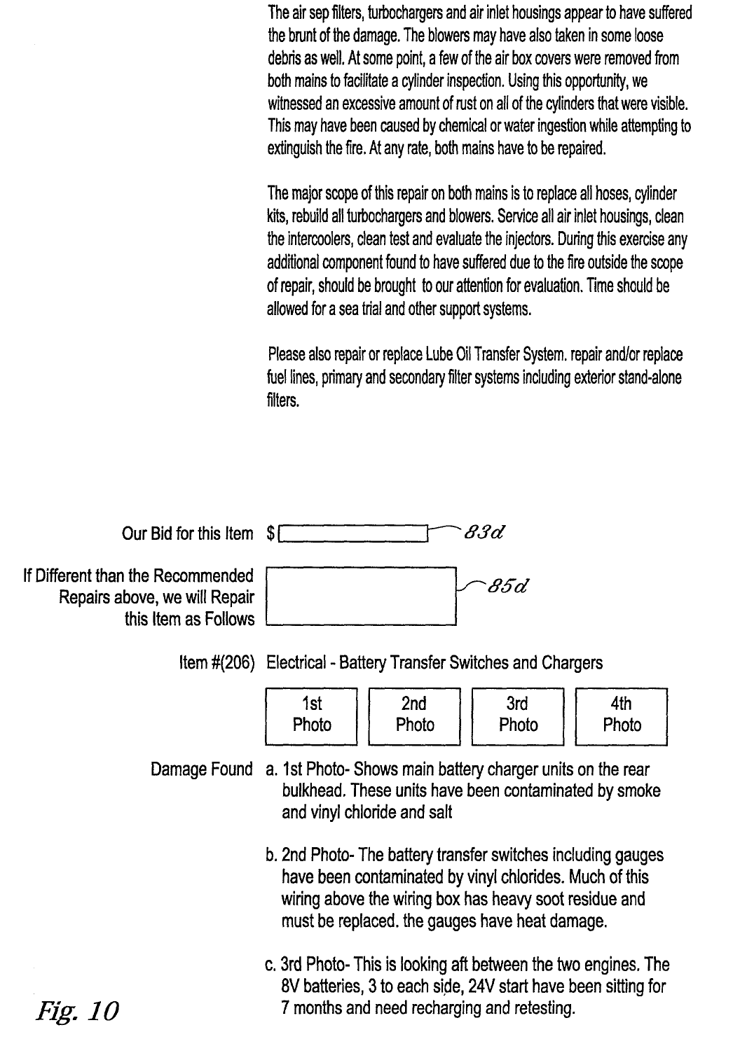

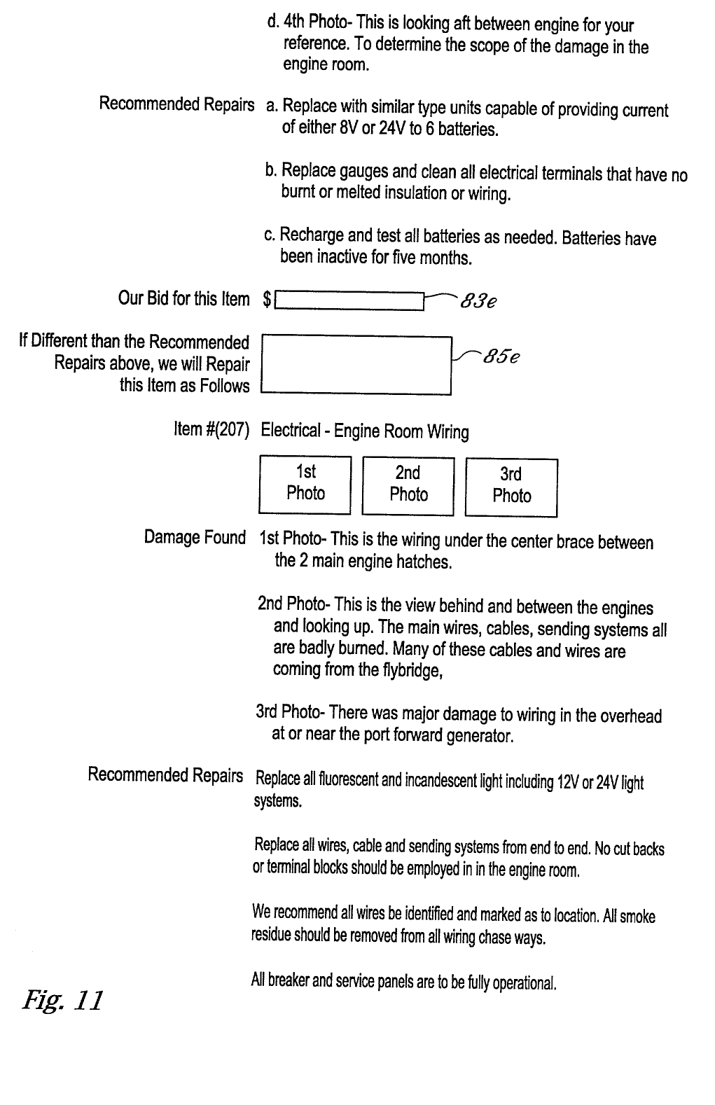

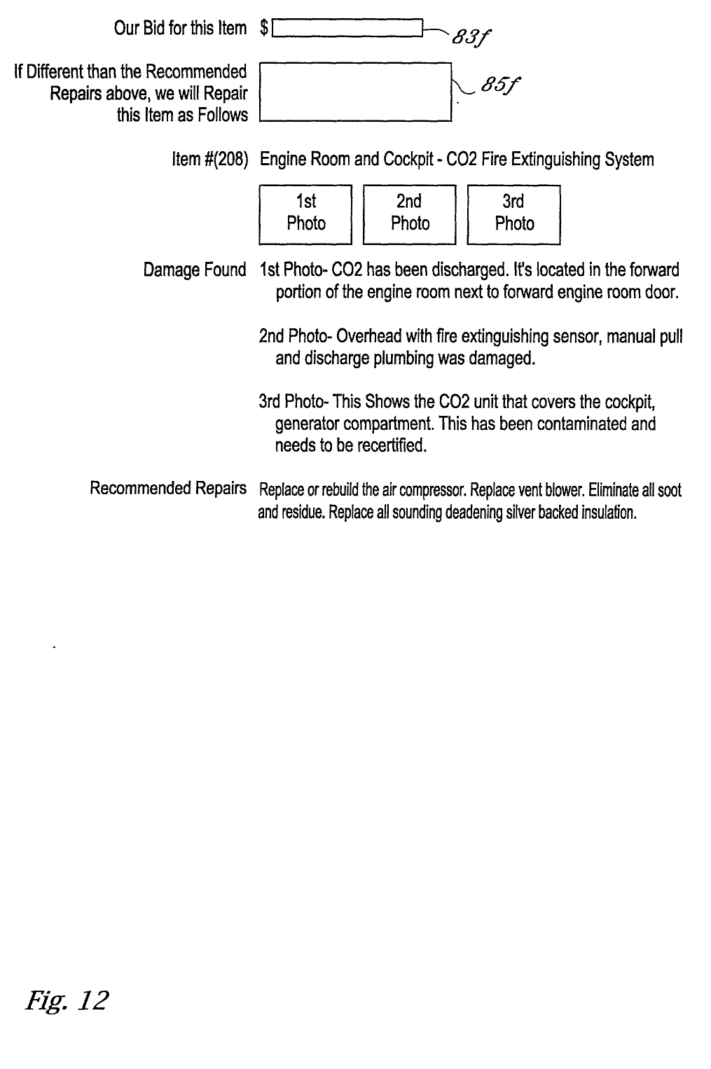

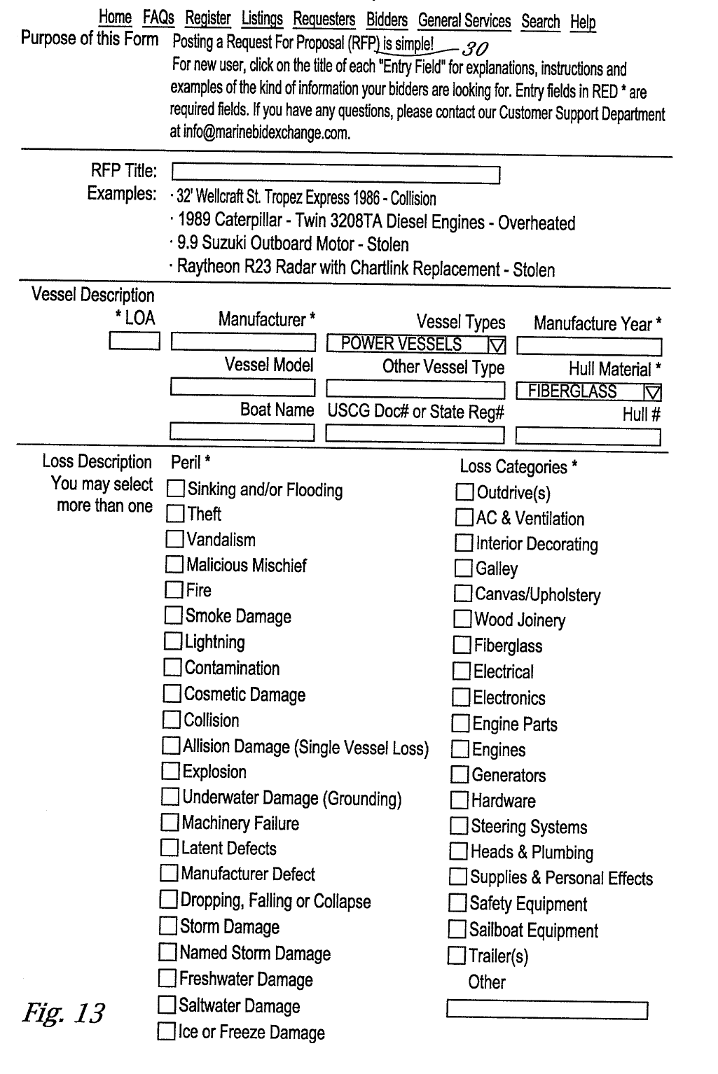

Following registration, a buyer/requester provides an RFP 30 including a narrative description of “damage found,” “recommended repairs,” and “photo uploads” 77/77a to describe the nature of the damage and recommended repairs, as is shown by Line 76 of FIG. 6. The buyer/requester 24 provides a description of “damages found” and “recommended repairs” 76a in the format shown in FIGS. 7 to 12, as is more fully described below.

An RFP 30 comprises at least one item but may include an unlimited number of items. A buyer/requester 24 may upload as many as four thumbnail photos per item. See Item Nos. 201 to 208 of FIGS. 7-12. Each thumbnail photo will automatically, if clicked upon, zoom up to a much larger scale photo. This is done to allow more elective images per page while maintaining an acceptable downloading speed. This also allows the viewer of each page of thumbnail photos 77 to make one's own choice of which thumbnails to zoom-up, rather than forcing the viewer to view all large photos.

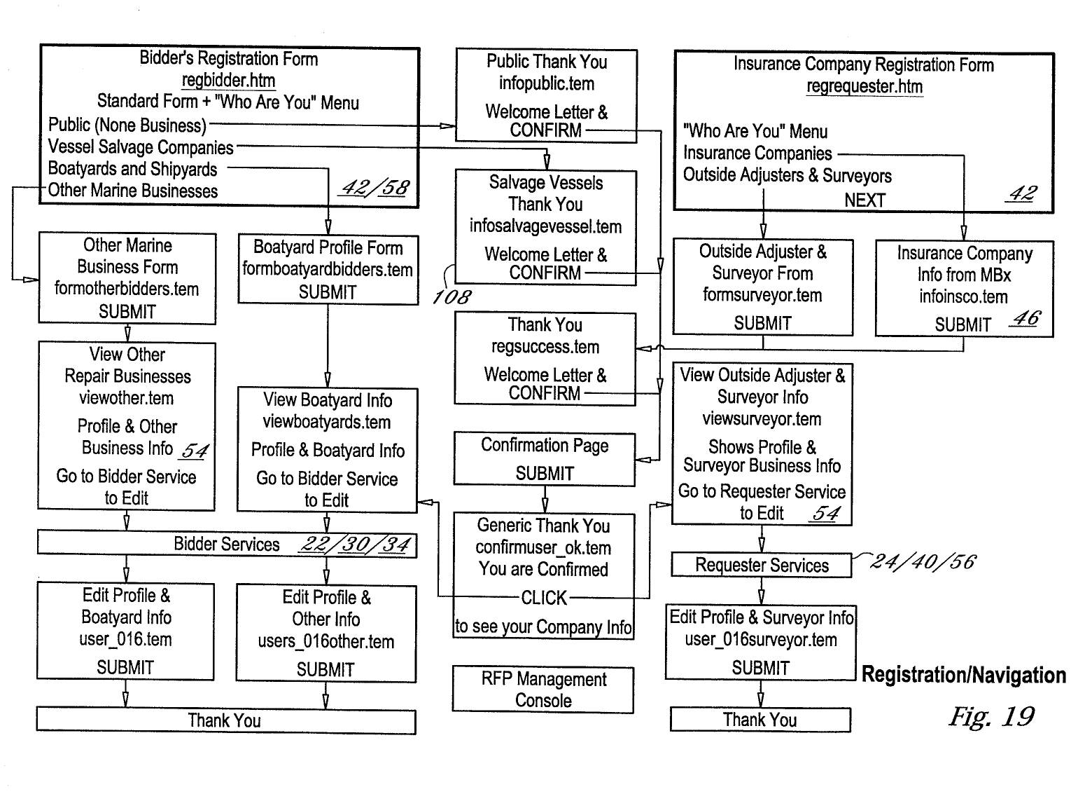

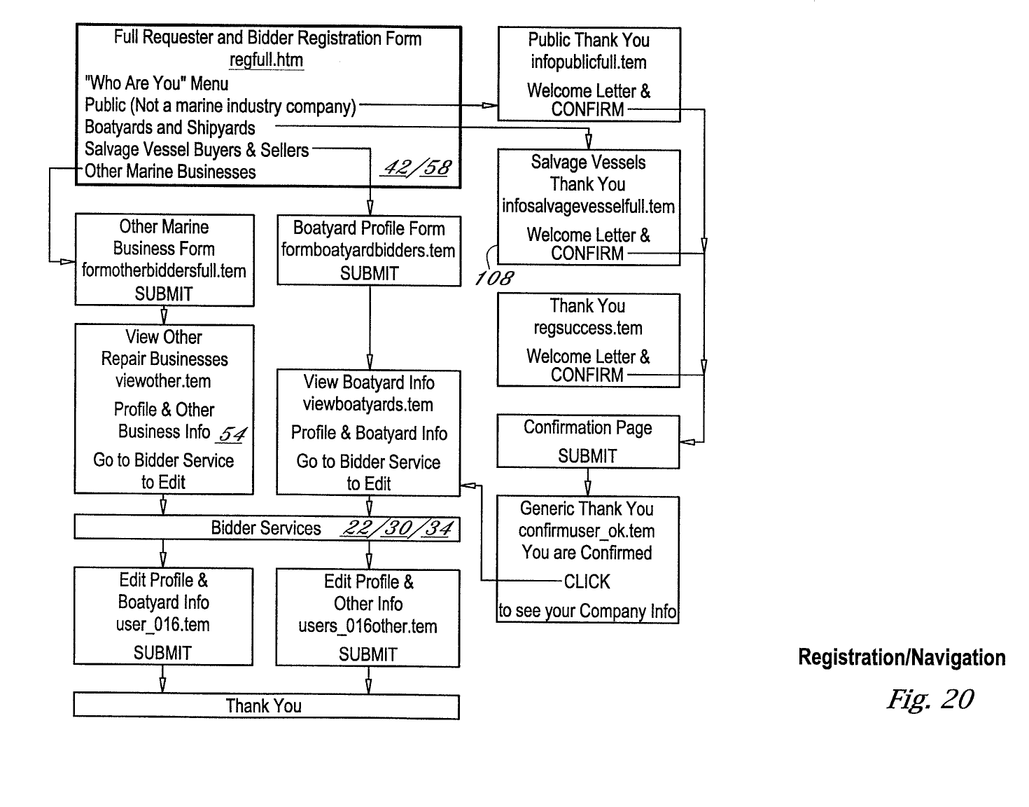

Users of this site, including both buyer/requesters and seller/bidders, may upload and size photos with their registration profiles or RFP items directly from their own computer. See FIGS. 19-20. The CNPU will automatically re-size a photo and express it as a predetermined sized thumbnail photo without the need for user cropping, copying or resizing and renaming photos for the thumbnail. This also removes the burden of having to upload both the larger photo which would require more time and coordination by a user.

One benefit of the above is that network seller/bidder 22 may generate a mini-page inclusive of written and graphic information, as is indicated by Line 70 of FIG. 6. This profile becomes available to the requester to evaluate the bidder repair capability.

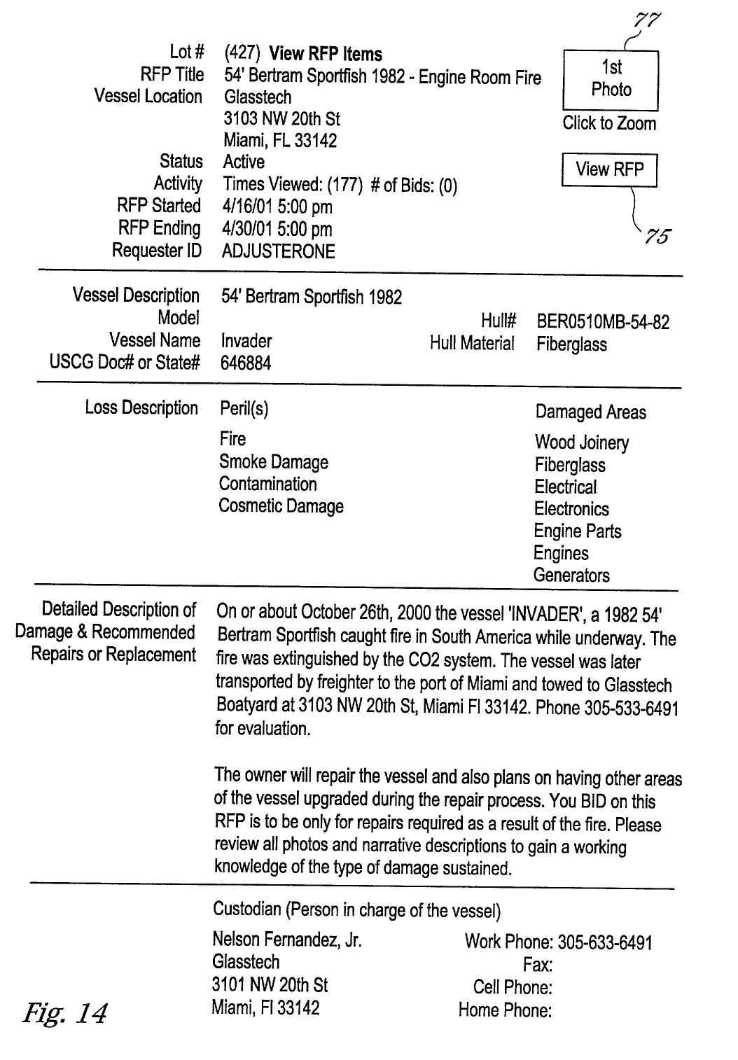

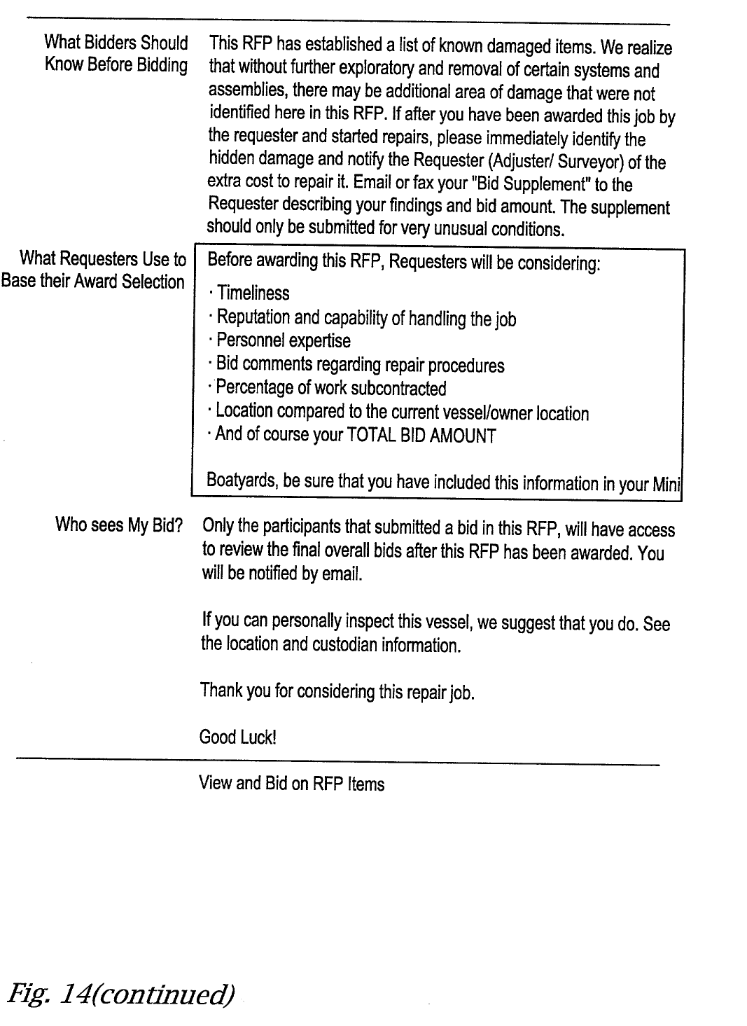

As above noted, elective pop-up tutorials 48 exist throughout the present system and, in FIG. 6 are particularly shown in databases 48A and 48B which are accessible to buyers and sellers as is indicated by Lines 72 and 74 respectively. The next step, when the system is employed in its RFP auction mode, is that of generation of the RFP 30. Therein, a requester 24 may employ forms from a database 56, of a type shown in FIG. 6 herewith. See also FIGS. 19-20. After this form is completed, the RFP 30 will appear on the system in the manner of the example of FIGS. 7-12. To access the detailed graphic and textual information of FIGS. 5-6, one may click on “view RFP” 75 of FIG. 14 or may simply click on any thumbnail photo 77 to see more of the subject of this RFP.

The generation and transmission of the proposal to the network server is shown as Line 76 in FIG. 6. Thereupon, the requester 24 may define a subset of network seller/bidders 22 suitable for receipt of the RFP in which a variety of criteria, both objective and subjective, may be employed. In an open bid scenario, the requester will then select the best candidate for the job. Therein, the requester may establish criteria, for given categories of services 46, on the basis of one or more of geography, capability, experience, peril classification, language spoken, and conditions of sale or offer. In many cases, a network seller/bidder will indicate an area of interest or non-interest, this in accordance with the form of FIG. 15 in which a network bidder is encouraged to complete, both as a matter of his own convenience and so that the system does not misuse resources in sending RFP notices of a type that a particular bidder would have no interest in.

In addition, a buyer/requester 24 is permitted to construct a “private auction” wherein the requester must approve all prospective sellers/bidders 22 in which he wishes to participate. Also, the buyer/requester may elect at the time of RFP setup to password protect the auction. Such auctions will, it is believed, become quite common inasmuch as, in certain niche industries, such as the marine industry, a buyer/requester will typically have a good sense of the qualified sellers/bidders to which he would entrust his work. Accordingly, it would not be unusual for a private boat owner or a boat manufacturer, having warranty or service requirements, to specify a short list of network seller bidders for consideration of his RFP. As such, the present system can readily be adapted to either impose such a short list for a private RFP auction or, as above set forth, apply general constraints relative to geography, peril classification or the like; or said criteria may be bypassed entirely.

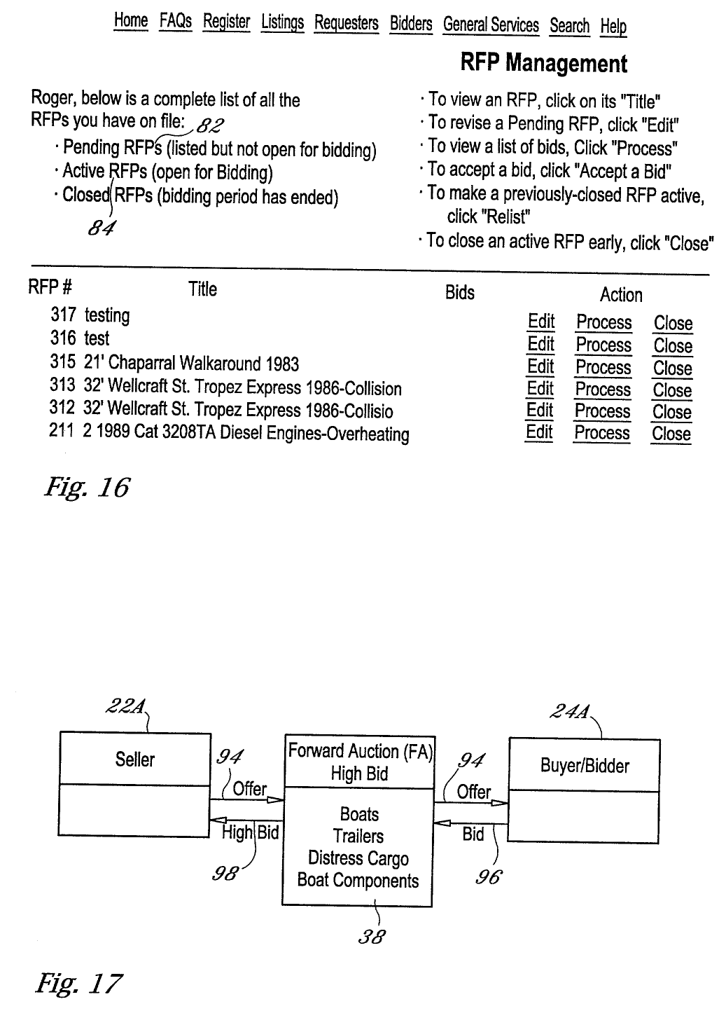

After an appropriate subset of candidates of seller/bidders has been determined, the RFP notices are transmitted to the selected group of network sellers/bidders by both e-mail and wireless means as in indicated by Line 78, and by a line segment 80 thereof which indicates receipt of the RFP notice by both e-mail and wireless means. Thereupon, seller/bidder 22, employing bidder elective pop-up tutorials 48B, as needed, and attaching his seller mini-pages 54, as needed, will generate a bid which is forwarded to server 20, as is indicated by Line 82 of FIG. 6. During the bidding process, the seller/bidder 22 views (typically five) items per page by electing to expand the thumbnail photos for a closer look at the actual damage as well as to evaluate the buyer/requester's “damage found” and recommended repairs.” The seller/bidder then enters his respective bid amount 83-83f and a narrative 8585f on how the repairs would be done if different than the buyer/requester's recommended repairs. See FIGS. 7 to 12, and FIGS. 19-20. The bidder then submits all items and moves on to the next page of item to evaluate and possibly bid on. After the bidder has placed bids on all items in the RFP 30, he may go back and change his bid or conditions of the bid on any item, using the final bid sheet. Once the bidder is happy with all his bids, the bidder selects “confirm bids” 84 so that his bids on all items become “active bids” and cannot be changed. See FIGS. 6 and 16. That is, the bidder must eventually bid on all items comprising an RFP 30 to produce a finalized bid that will be processed.

After the RFP period has ended, the buyer/requester is automatically invoiced for auction service fees. After MBx is paid, an e-mail notice is sent to the buyer/requester to process all bids, as is indicated by Line 86. In selecting the winning bidder, the requester 24 may apply his own personal and subjective consideration to all bids, not only the lowest bid as is typical in the prior art of RFP auction systems. Therein, although the fee paid by the buyer/requester is a function of the lowest good faith bid, the requester is under no obligation to accept the lowest bid. In other words, for any of a number of reasons, a requester may choose to select a bidder other than the one offering the lowest price for the RFP. The buyer/requester may also elect to “reject all bids.” If so, e-mail notices 86 are sent to all selected bidders that all bids of that RFP were rejected. The buyer/requester is however still charged a transaction fee but is given credit towards his next RFP. Line 88 of FIG. 6 indicates the acceptance of a bid by the requester and the transmission of such acceptance to server 20 whereupon the successful bidder is notified as is indicated by Line 90. The selected bidder is then asked to confirm his acceptance of the bid, which is indicated by Line 92.

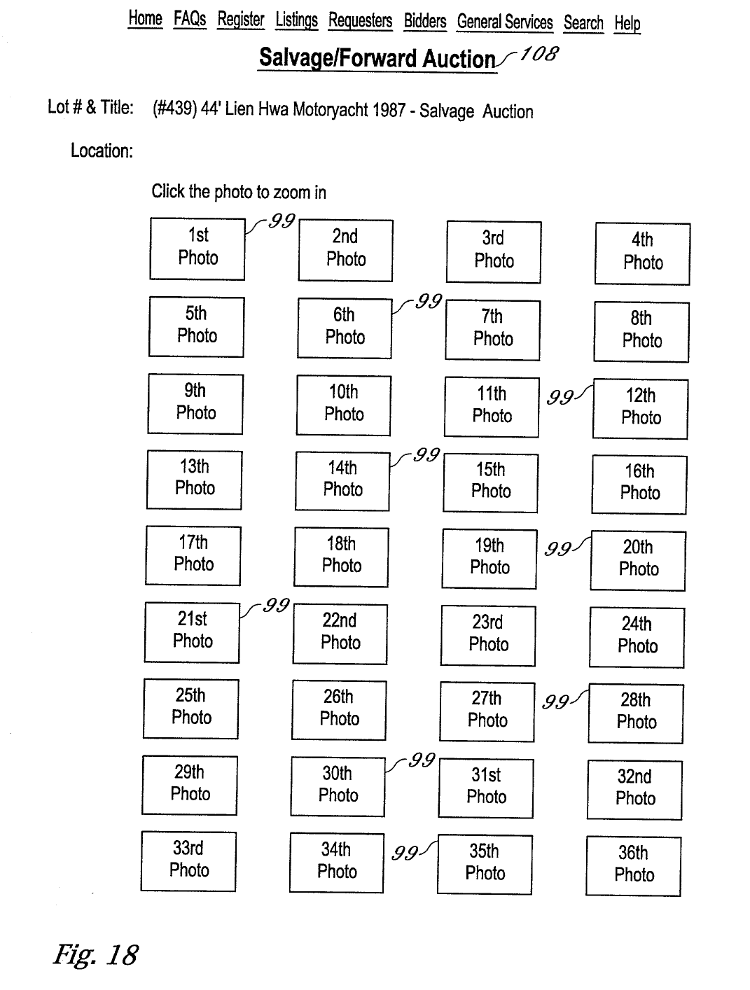

The forward auction 50 of the present system is much simpler in concept than is the above described RFP auction and is shown conceptually in FIG. 17 and, more particularly, in said FIG. 6 with reference to those lines using the nomenclature FA. As be noted in FIG. 17, the forward auction 50 is simply a matter of the forward seller 22A listing a particular cargo or product 38 or vessel and the transmission of such an offer 94 to forward buyer 24A who, if interested in product 38, will generate a bid 96 whereupon the forward auction 50 will simply transmit high bid 98 to the forward seller 22A. Forward auction subjects may be selectably viewed by clicking upon any of thumbnail photos 99 of FIG. 18. In the present system, a seller may also view the bid history of a subject should he wish to do so. The above is shown in further detail in the system flow diagram of FIG. 17 in which offer 94 may be seen emanating from a seller in which data database 38/44 may be used to attach an appropriate jpeg to the offer if the seller has not already done so. Thereupon, the offer of sale will be transmitted as indicated by Line 100 to the forward auction 50 of the server 28. Notice of the seller's offer is then furnished to a prospective buyer as is indicated by Line 102. An FA bid 96 then be forthcoming from an FA bidder as is indicated by Line 96. In a “sealed bid” auction, the high bid 98 is communicated to the seller 22A who, if he wishes to accept the high bid, will indicate his acceptance thereof as is indicated by Line 106, whereupon confirmations are sent out to both parties by the server and the commission is paid by the seller while the purchase price is paid by the buyer 24A to the forward auction 50. In an open bid auction, the highest bid is the winning bid, which is determined by the server 28 immediately at the end of the auction

It is noted that a forward auction 50 and, particularly, a salvage auction 108 (see FIGS. 18-20 and 23) of a vessel cargo or any other commodity may function concurrently with an RFP auction 28 of the same vessel cargo or any other commodity as above set forth, this to effectively determine if a vessel is a total loss or if it can be cost-effectively repaired.

In a damage or salvage cargo auction, FA bid 96 comprises two parts, namely:

(a) Bid to purchase as is; and

(b) Bid to repair (not purchase) for continued shipment to final destination. This corresponds to the function of Line 76 of a proposal in response to an RFP. See FIG. 6.

A screen page of the program showing the manner in which the system user can readily insert himself into different steps or aspects of the inventive system is shown in FIGS. 14-16 which indicates the manner in which a network member may observe pending, active and closed RFPs and, as well, may, within time sensitive parameters, effect a revision of a pending RFP or a re-listing of an existing RFP. The right side of FIG. 16 is therefore a management page of the system,

In FIGS. 19 and 20 are shown, in greater detail, the functions associated with the use of registration form database 42, requester registration forms 56 and bidder registration forms 58. Therein the adaptation of the present system to the particular needs of different network members, e.g., vessel salvage companies, boatyard and shipyards, insurance companies, outside adjusters and surveyors, salvage vessels, brokers, and interested members of the public are accommodated.

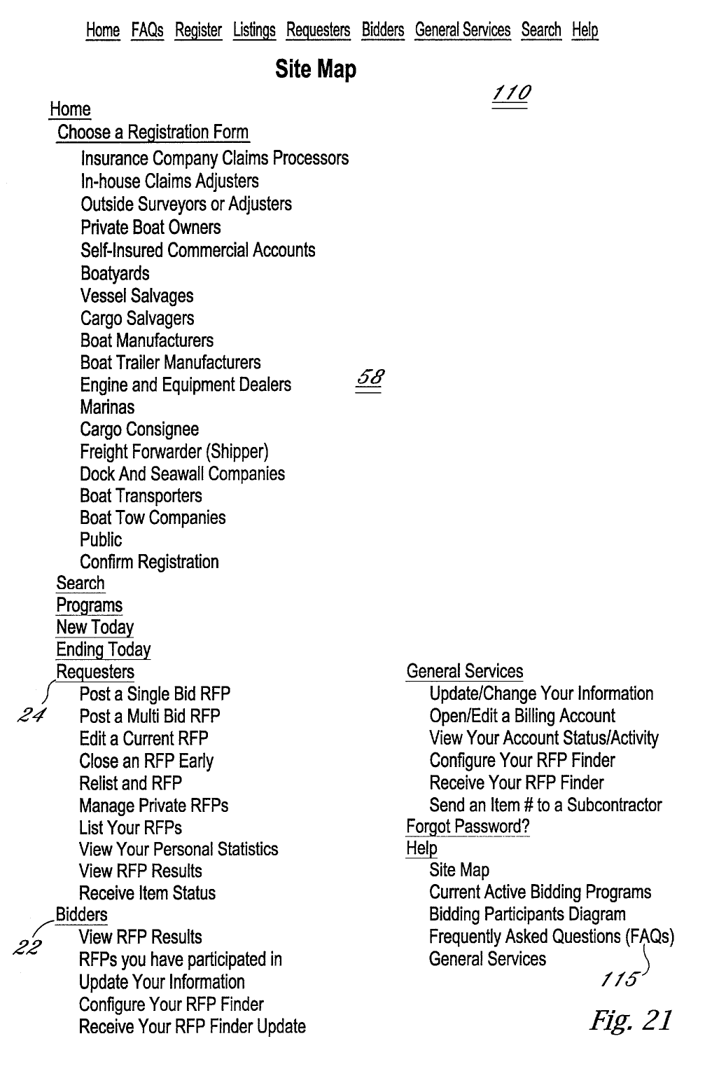

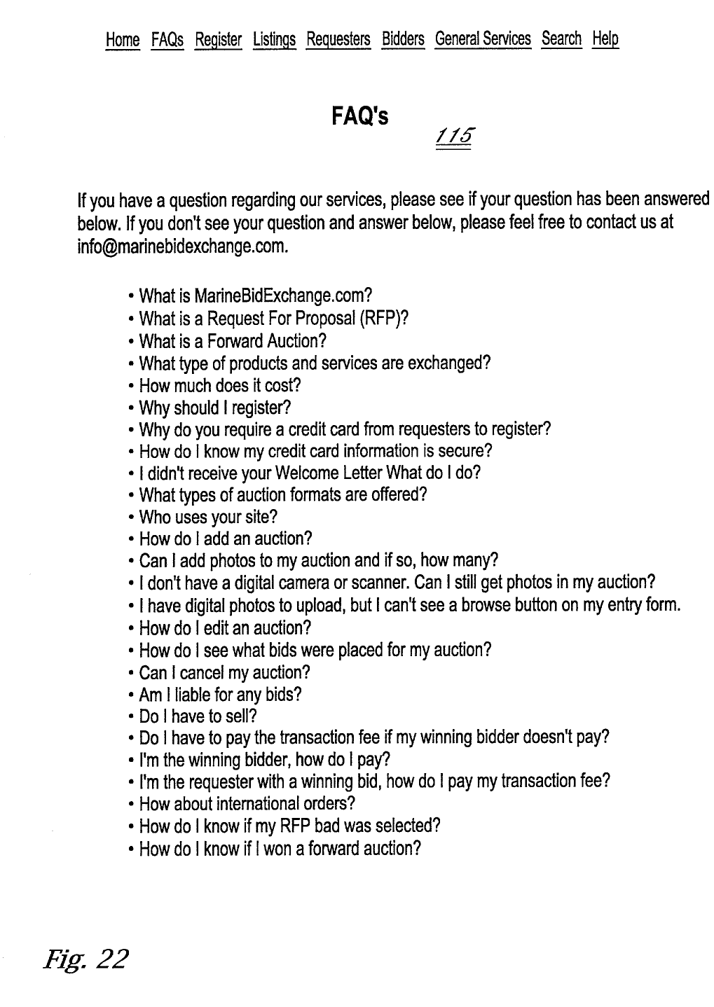

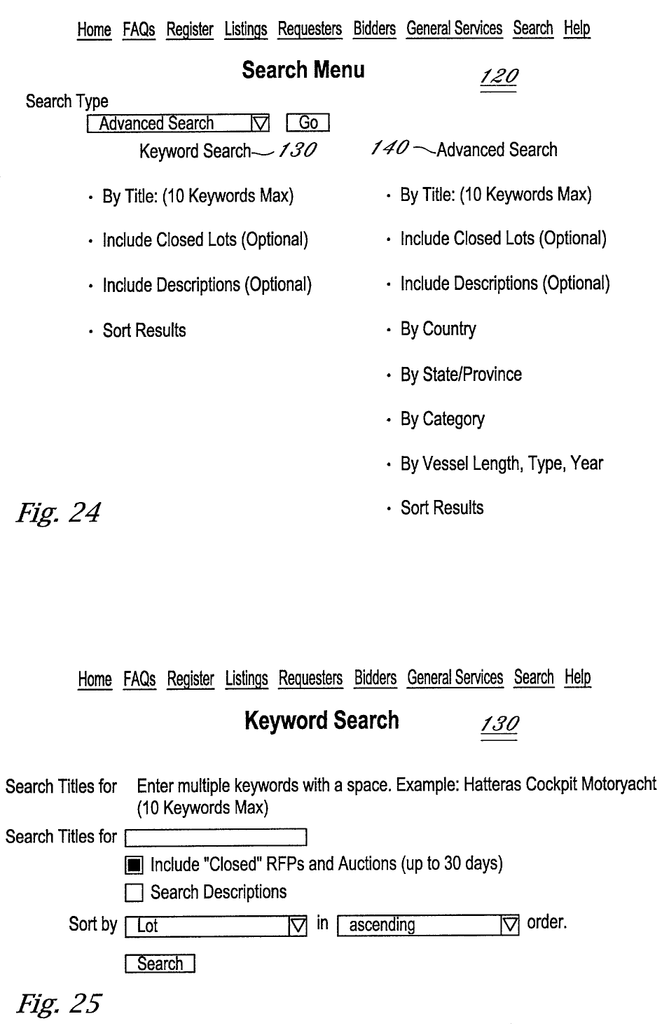

Shown in FIG. 21 is a screen page of a site map 110 of the present procurement auction system showing thereof the direct linkage from the site map to an applicable registration form, and other forms, such as forms 58 employed by bidders 22. Also linked to site map 110 is a search program 120 and frequently asked questions (FAQs) 115 which are further shown in FIGS. 24 and 22 respectively.

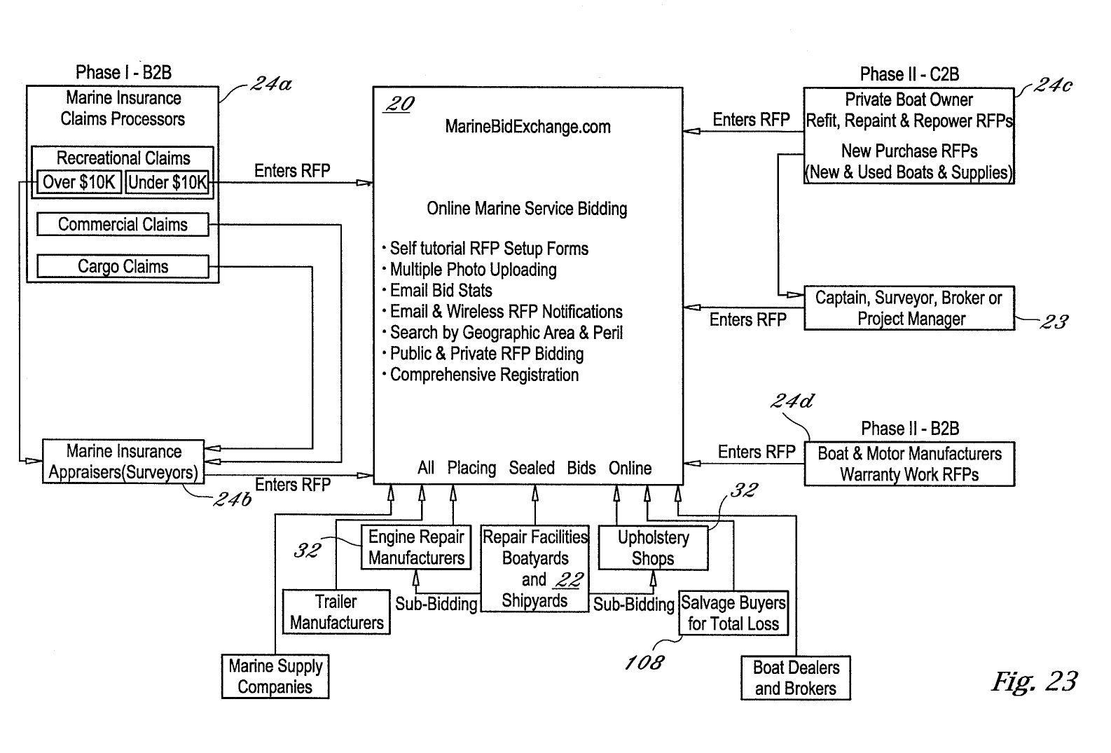

In FIG. 23 is shown a summary of the various benefits and applications of the system, this inclusive of the above-described sub-bidding functions 32 available to network sellers/bidders 22. Thereby, through FIG. 23 there may be appreciated the range of both B2B (business-to-business) and C2B (consumer-to-business) applications of the system, this both at various points in the chain of channel of distribution of marine related goods and services. Compare, for example, Phase I-B2B and Phase II-B2B.

With respect to marine insurers 24a, in Phase I of B2B their benefits are:

Lower loss ratios because of lower claim processing expenses

Avoidance of “captured” vessels

More competitive and lower bids

Faster, easier and more credible bids

Concurrent repairs and salvage bidding

Open and easier claim supervision

Less litigation.

With respect to marine surveyors 24b in Phase I of B2B, their benefits are:

Self-tutorial RFP input forms

For inside adjusters, smaller losses that are easier and faster

Ease of digital photo uploading

Printed photo scanning service

Unbiased bid data

Links to their own website

More visibility and creditability, thus more jobs

Available at all times

With respect to private boat owners 24c in Phase II of C2B, their benefits are:

Lower repair and maintenance cost

More competitive and lower bids

Avoidance of “captured” vessels

Faster, easier and more credible service

With respect to manufactures 24d in Phase II of B2B, and their warranty work, their benefits are:

Lower cost of repairs

Faster turnaround

Self-tutorial RFP input forms

Easy digital photo uploading

Printed photo scanning service

Links to on-line manuals

Links to their own website

Available at all times

With respect to captains, brokers and project managers 23, Phase II C2B benefits are:

Self-tutorial RFP input forms

Easy digital photo uploading

Printed photo scanning service

Links to their own website.

Available at all times

With respect to all categories shown at the center bottom of FIG. 23, the benefits of the inventive system are:

Lower the cost of finding work at any time

More damage data and therefore better bid accuracy

More stable employee workload

Less litigation or conflict regarding costs.

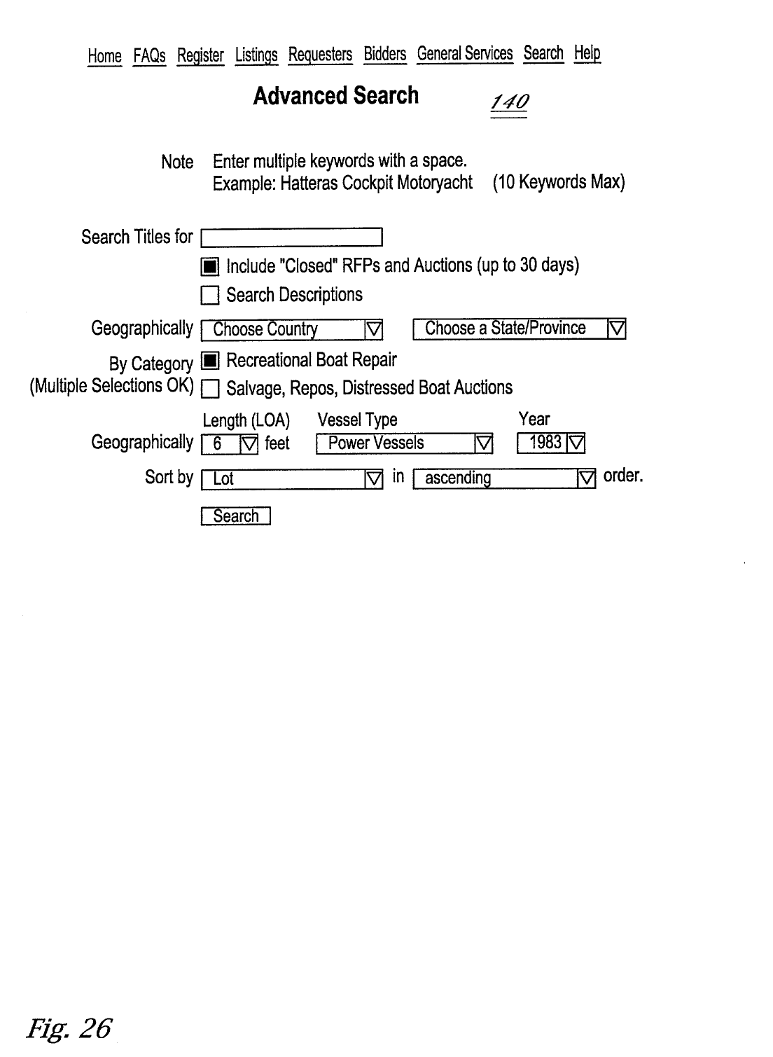

FIGS. 24 to 26 illustrate a system search menu 120 which is linked to a keyword search 130 and advanced search 140 respectively.

While there has been shown and described the preferred embodiment of the MBx invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

We claim:

1. An on-line RFP procurement auction system with bidder sub-auctions, using an Internet based communications network of network members inclusive of network buyers/requesters and network sellers/bidders, for processing an RFP for goods and services through at least one central network processing unit (“CNPU”) and operating software therefore, the system comprising:
(a) a database for each category of goods and services offered or desired by network members of the system;
(b) photo upload means for remote use by network buyers to particularly illustrate and explain desired RFP requirements;
(c) means for network buyers to generate said RFP for goods or services displayed by jpegs and the like of photo uploads together with alpha numeric RFP data;
(d) means for transmitting said RFPs inclusive of jpegs to said CNPU;
(e) means for e-mail and wireless distribution of RFP notices to those network sellers/bidders; that have asked for notices within selectable categories of RFP's.
(f) means for enabling a network seller/bidder to submit an encrypted bid to said CNPU; and
(g) means within said CNPU for the requester, after an RFP period has closed, to view all bids along with a bidder's optional profile (mini-webpage) to develop a knowledge-based selection of his preferred bidder; and
(h) means for all participatory bidders of said RFP to view each of said RFP's.

2. The system as recited in claim 2, further comprising:
means for providing a link to a seller/bidder's website, which link is provided with the seller/bidder's bid.

3. The system as recited in claim 1, including:
means for furnishing a particular form to a network buyer for use with a particular category of RFP.

4. The system as recited in claim 1, further comprising:
self-tutorials for teaching a network buyer/requester proper use of said form for each category thereof.

5. The system as recited in claim 1, in which said means (e) comprises:
means for enabling said buyer/requester to evaluate network bidder candidates upon a basis consisting of one or more of geography, capability, experience, peril classification, language spoken, and special conditions of sale or offer.

6. The system as recited in claim 1, further comprising:
means for establishing a member profile through use of a registration questionnaire.

7. The system as recited in claim 1, in which said network buyer/requester consists of a member of a group selected from marine insurance companies, private boat owners, self-insured individuals, boat manufacturers, homeowners, marinas, and private and commercial waterfront facilities.

8. The system as recited in claim 1, in which said network sellers/bidders consist of a member of a group selected from boat yards, inflatable dinghy dealers, vessel trailer manufacturers, vessel towing companies, vessel and cargo salvors, vessel transporting companies, dock and seawall companies, and beach restoration companies.

9. The system as recited in claim 1, further comprising:
means for charging commissions to network buyers for a lowest RFP bid even if such lowest bid is not selected by said buyer.

10. The system as recited in claim 1, in which:
said means for network buyers/requesters to generate RFPs comprises RFP listing preview means for use during an RFP pending period preceding an active RFP.

11. The system as recited in claim 1, further comprising:
means for defining an auction period during which a RFP subject description may be added to but not deleted.

12. The system as recited in claim 1 further comprising:
means for providing selectable categories of sub-contractor databases, consisting of network members, for exclusive use by a network buyer/requester for formulation of responses to active RFPs.

13. The system as recited in claim 12, in which said database categories include engine repair facilities and upholstery shops.

14. The system as recited in claim 1, further comprising:
means for establishing a limited RFP auction consisting of a selectable subset of network seller/bidders.

15. The system as recited in claim 1, further comprising:
means for limiting receipt by sellers/bidders of RFPs to categories and subjects of particular interest thereto.

16. The system as recited in claim 14, further comprising:
database search means for identifying candidate network member bidders for said limited auction.

17. The system as recited in claim 1, further comprising:
means for facilitating a forward auction of a designated product or vessel.

18. The system as recited in claim 17, in which said forward auction comprises a salvage auction.

19. The system as recited in claim 18, in which said salvage auction may occur in combination with a RFP auction of the same vessel.
